(19) United States
(12) Patent Application Publication
(10) Pub. No.: US 2023/0279200 A1
(43) Pub. Date: Sep. 7, 2023

(54) NON-HALOGENATED PHOSPHORUS-BASED FLAME RETARDANT, FLAME-RETARDANT POLYMER RESIN USING THE SAME, AND PRODUCTION METHOD FOR SAME

(71) Applicant: RESEARCH & BUSINESS FOUNDATION SUNGKYUNKWAN UNIVERSITY, Suwon-si (KR)

(72) Inventors: Jung Heon LEE, Seoul (KR); Jun Hyuk HEO, Suwon-si (KR); Sun Hwan JEONG, Seoul (KR); Min Jeong KIM, Yongin-si (KR); Jin Woong LEE, Seoul (KR)

(73) Assignee: RESEARCH & BUSINESS FOUNDATION SUNGKYUNKWAN UNIVERSITY, Suwon-si (KR)

(21) Appl. No.: 18/019,988

(22) PCT Filed: Jun. 15, 2021
(86) PCT No.: PCT/KR2021/007428

§ 371 Date: Feb. 6, 2023

(30) Foreign Application Priority Data
Aug. 6, 2020 (KR) 10-2020-0098510
Apr. 27, 2021 (KR) 10-2021-0054253

(51) Int. Cl. C08K 5/529; C08J 3/12

(52) U.S. Cl. CPC C08K 5/529; C08J 3/128; C08K 2201/019; C08J 2375/04; C08J 2323/06; C08J 2323/08

(57) ABSTRACT

The present invention relates to a non-halogenated phosphorus flame retardant containing adenosine triphosphate (ATP) as an organic compound that supplies energy for life activity, a flame-retardant polymer resin having the non-halogenated phosphorus flame retardant coated thereon, and a method for preparing the same. The non-halogenated phosphorus flame retardant according to an embodiment of the present invention contains adenosine triphosphate (ATP).

### FIELD

The present disclosure relates to a non-halogenated phosphorus flame retardant containing adenosine triphosphate (ATP) as an organic compound that supplies energy for life activities, a flame-retardant polymer resin onto which the same is applied, and a method for preparing the same.

### DESCRIPTION OF RELATED ART

In general, polyurethane resin is used in various industries such as automobiles, electric wires, pneumatic hoses, and mattresses due to its excellent abrasion resistance, excellent mechanical properties and elasticity, etc. However, due to its weak flame-retardant properties, its use is extremely limited in household and industrial fields that require very good flame retardancy.

To increase the flame retardancy of the polyurethane material, a halogenated flame retardant has been widely used. However, the halogenated flame retardant generates toxic gas harmful to the human body during combustion thereof. Thus, its use is prohibited by the regulations of the International Environmental Organization.

Therefore, the development of a phosphorus flame retardant which is an eco-friendly material, is actively being carried out. A conventional phosphorus flame retardant requires two or greater additives to enhance the flame retardancy, and has a low phosphorus content, thereby making it difficult to achieve high flame retardancy.

### DISCLOSURE

### Technical Purpose

One purpose of the present disclosure is to provide a non-halogenated phosphorus flame retardant that may improve flame retardancy of a polymer resin via a multi-synergistic effect of three phosphate groups, ribose and adenine base present in non-toxic adenosine triphosphate (ATP).

Another purpose of the present disclosure is to provide a non-halogenated phosphorus flame-retardant polymer resin including a polymer resin and the non-halogenated phosphorus flame retardant coated on a surface of the polymer resin, and a method for preparing the same.

### Technical Solution

The non-halogenated phosphorus flame retardant according to an embodiment of the present disclosure includes adenosine triphosphate (ATP).

In one embodiment, the non-halogenated phosphorus flame retardant may be combusted to form char in a form of glass fragments.

Further, the non-halogenated phosphorus flame retardant exhibits a volume expansion by at least 10 times, preferably 70 to 80 times of an initial volume thereof during combustion thereof.

In one example, the non-halogenated phosphorus flame retardant according to an embodiment of the present disclosure includes cytidine triphosphate (CTP).

In one embodiment, the non-halogenated phosphorus flame retardant may be combusted to form char in the form of glass fragments.

Further, the non-halogenated phosphorus flame retardant exhibits a volume expansion by at least 10 times, preferably 70 to 80 times of an initial volume thereof during combustion thereof.

In one example, the non-halogenated phosphorus flame retardant according to an embodiment of the present disclosure includes thymidine triphosphate (TTP).

In one embodiment, the non-halogenated phosphorus flame retardant may be combusted to form char in the form of glass fragments.

Further, the non-halogenated phosphorus flame retardant exhibits a volume expansion by at least 10 times, preferably 70 to 80 times of an initial volume thereof during combustion thereof.

In one example, the non-halogenated phosphorus flame retardant according to an embodiment of the present disclosure includes guanosine triphosphate (GTP).

In one embodiment, the non-halogenated phosphorus flame retardant may be combusted to form char in the form of glass fragments.

Further, the non-halogenated phosphorus flame retardant exhibits a volume expansion by at least 10 times, preferably 70 to 80 times of an initial volume thereof during combustion thereof.

In one example, a non-halogenated phosphorus flame-retardant polymer resin as another embodiment of the present disclosure may include a polymer resin and the non-halogenated phosphorus flame retardant coated on a surface of the polymer resin and thus may exhibit flame-retardant properties.

In this regard, the polymer resin may preferably include at least one selected from polyurethane, polyethylene, EVA (Ethylene-vinyl acetate) and cotton fibers. The non-halogenated phosphorus flame retardant may be contained in an amount of 30 wt % or greater based on a total weight of the non-halogenated phosphorus flame-retardant polymer resin.

Further, the present disclosure provides a method for preparing a non-halogenated phosphorus flame-retardant polymer resin as another embodiment of the present disclosure. Specifically, the method comprises preparing an aqueous solution containing at least one selected from adenosine triphosphate (ATP), cytidine triphosphate (CTP), thymidine triphosphate (TTP) and guanosine triphosphate (GTP); immersing and reacting a polymer resin in and with the aqueous solution, and drying the polymer resin after the reaction.

In one embodiment, the aqueous solution may be deionized (DI) water of pH 5 to 8.

In one embodiment, the aqueous solution may be a buffer solution of pH 5 to 8.

Further, it is preferable to perform the drying at a temperature of 25 to 60° C.

### Technical Effect

The flame retardant according to the present disclosure contains adenosine triphosphate (ATP), cytidine triphosphate (CTP), thymidine triphosphate (TTP) or guanosine triphosphate (GTP) including phosphorus (P), nitrogen (N), and carbon (C) which are three essential components in the flame retardant material in a molecule itself thereof. Thus, even without presence of other additives, the flame retardant according to the present disclosure may exhibit excellent flame-retardant properties based on the multi-synergistic effect of the three phosphate groups, ribose, and nitrogen-containing base. The flame retardant according to the present disclosure may be applied to several polymer resins to improve the flame retardancy of the polymer resin.

In addition, the materials contained in the flame retardant according to the present disclosure are organic compounds produced daily to perform various life activities in cells, and thus are non-toxic. Thus, the flame retardant according to the present disclosure may be applied, as an eco-friendly flame retardant, to a food container and a medical container.

In addition, according to the present disclosure, when preparing the non-halogenated phosphorus flame-retardant polymer resin, the pH of the aqueous solution may be adjusted to 5 to 8 to increase the solubility of ATP, CTP, TTP and GTP therein such that various flame retardancy materials may be coated on the polymer resin. In particular, when the buffer solution of pH 5 to 8 is used as an aqueous solution, deformation and destruction of the flame retardant material may be prevented such that the flame retardant ability may be maximized.

Further, the drying temperature may be adjusted to 25 to 60° C., thereby preparing the non-halogenated phosphorus flame-retardant polymer resin having optimal flame-retardant properties while maintaining the physical properties of the polymer resin.

### BRIEF DESCRIPTION OF DRAWINGS

FIG. 1 shows a non-halogenated phosphorus flame retardant coated polymer resin according to an embodiment of the present disclosure, and flame-retardant properties thereof.

FIG. 2A shows a SEM image of PU-ATP prepared according to Present Example 1 of the present disclosure.

FIG. 2B shows the results of analyzing the chemical composition of the polyurethane surface before and after ATP coating using X-ray photoelectron spectroscopy (XPS).

FIG. 2C shows C1s XPS spectra of the polyurethane surface before and after ATP coating.

FIG. 3A shows the result of comparing the flame-retardant properties of Present Example 1 and Comparative Example 1 of the present disclosure with each other.

FIG. 3B shows thermal images during combustion thereof of Present Example 1 and Comparative Example 1 of the present disclosure.

FIG. 3C shows SEM images before and after combustion of Present Example 1 of the present disclosure.

FIG. 4 shows the con-calorimeter test results of Present Example 1 and Comparative Example 1 of the present disclosure.

FIG. 5 shows the results of comparing the flame-retardant properties of adenosine triphosphate (ATP) and ammonium polyphosphate (APP) as a conventional phosphorus flame retardant with each other.

FIG. 6 shows the evaluation results of flame-retardant properties based on the pH of the aqueous solution.

FIG. 7 shows the evaluation results of flame-retardant properties based on whether or not the aqueous solution is the buffer solution.

FIG. 8 shows the evaluation results of flame-retardant properties based on drying temperature conditions.

Various embodiments are now described with reference to the drawings, wherein like reference numbers are used throughout the drawings to indicate like elements. For description of the present disclosure, specific details are presented to provide an understanding of the present disclosure. However, it is clear that these embodiments may be practiced without the specific details. In other instances, each of well-known structures and devices is shown in a block diagram form in order to facilitate describing the embodiments.

### DETAILED DESCRIPTIONS

Hereinafter, embodiments of the present disclosure will be described in detail with reference to the accompanying drawings. The present disclosure may have various changes and modifications. Thus, specific embodiments are illustrated in the drawings and described in detail in the text. However, this is not intended to limit the present disclosure to a specific disclosure form. It should be understood that the present disclosure includes all changes, equivalents, and substitutes included in the spirit and technical scope of the present disclosure. In describing the drawings, like reference numbers are allocated to like elements.

The terminology used herein is for the purpose of describing particular embodiments only and is not intended to limit the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof.

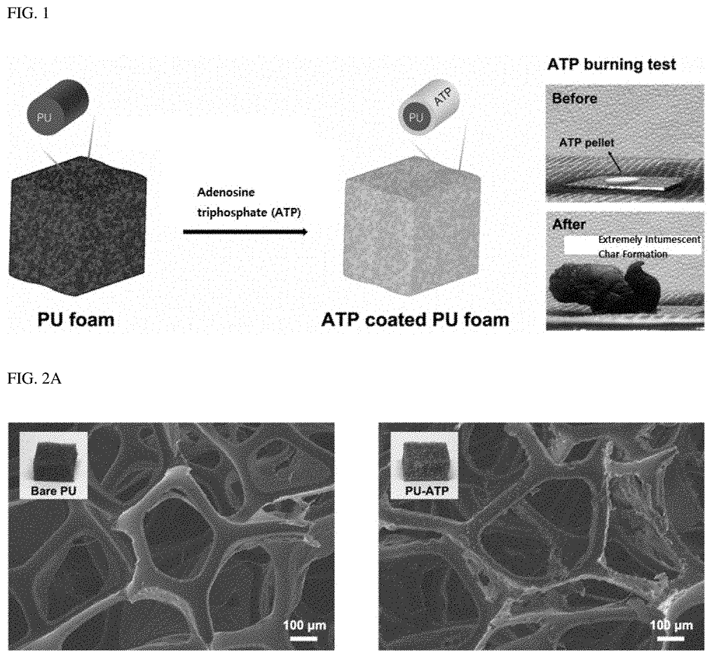

FIG. 1 shows a polymer resin coated with a non-halogenated phosphorus flame retardant and flame-retardant properties thereof according to an embodiment of the present disclosure.

Referring to FIG. 1, the non-halogenated phosphorus flame retardant according to an embodiment of the present disclosure includes adenosine triphosphate (ATP).

Adenosine triphosphate (ATP) is an important biomolecule that provides energy for various biochemical processes in living organisms, including excitation, muscle contraction, and nerve conduction in chemosynthesis.

As shown in FIG. 1, adenosine triphosphate (ATP) is composed of three phosphate groups, ribose and adenine base. A molecule itself thereof contains phosphorus (P), nitrogen (N), and carbon (C), which are three essential components in a flame retardant material. Thus, the adenosine triphosphate (ATP) can exhibit excellent flame retardancy.

In one embodiment, the non-halogenated phosphorus flame retardant may be combusted to form char in the form of glass fragments to improve flame retardancy of various polymer resins.

Further, the non-halogenated phosphorus flame retardant according to the present disclosure may exhibit a volume expansion by at least 10 times, preferably 70 to 80 times of an initial volume thereof during combustion thereof. Thus, the non-halogenated phosphorus flame retardant according to the present disclosure may impart the excellent flame retardancy to the polymer resin at a smaller amount thereof.

This is due to the multi-synergistic effect between the three phosphate groups, adenine base and ribose contained in adenosine triphosphate (ATP).

Specifically, three phosphate groups act as an acid source and may be released at a relatively low temperature (about 160 to 200° C.) to promote the formation of char in the form of glass fragments.

Ribose acts as a char source and may be combusted to form char in the form of glass fragments.

Adenine is a nitrogen-containing base and acts as a blowing agent to release incombustible gases such as ammonia during combustion thereof.

Therefore, the adenosine triphosphate (ATP)-containing flame retardant according to the present disclosure may exhibit excellent flame-retardant properties via the multi-synergistic effect of three phosphate groups, ribose and adenine base, without the presence of other additives, and thus may be applied to several polymer resins to improve the flame retardancy of the polymer resin.

In addition, the adenosine triphosphate (ATP) contained in the flame retardant according to the present disclosure is an organic compound produced daily to perform various life activities in cells and thus is non-toxic. Thus, the flame retardant according to the present disclosure may be applicable, as an eco-friendly flame retardant, to the food containers and medical containers.

In one example, the non-halogenated phosphorus flame retardant according to an embodiment of the present disclosure includes cytidine triphosphate (CTP).

Like the adenosine triphosphate (ATP), cytidine triphosphate (CTP) is a material containing ribose as pentose, and three phosphate groups, and has cytosine as a base.

Cytidine triphosphate (CTP) also contains phosphorus (P), nitrogen (N), and carbon (C), which are three essential components in the flame retardant material in a molecule itself thereof, and thus may exhibit excellent flame retardancy.

In one embodiment, the non-halogenated phosphorus flame retardant may be combusted to form the char in the form of glass fragments to improve flame retardancy of various polymer resins.

Further, the non-halogenated phosphorus flame retardant in accordance with the present disclosure exhibits the volume expansion by at least 10 times, preferably 70 to 80 times of the initial volume thereof during combustion thereof, and thus may impart excellent flame retardancy to various polymer resins even at a small amount.

This is due to the multi-synergistic effect between the three phosphate groups, cytosine base and ribose contained in cytidine triphosphate (CTP). Therefore, the non-halogenated phosphorus flame retardant in accordance with the present disclosure may exhibit excellent flame-retardant properties without the presence of other additives, and thus may be applied to several polymer resins to improve the flame retardancy of the polymer resin.

In one example, the non-halogenated phosphorus flame retardant according to an embodiment of the present disclosure includes thymidine triphosphate (TTP).

Like adenosine triphosphate (ATP), thymidine triphosphate (TTP) is a material that contains ribose as pentose and three phosphate groups, and has thymine as a base.

Thymidine triphosphate (TTP) also contains phosphorus (P), nitrogen (N), and carbon (C), which are three essential components in flame retardant materials in a molecule itself thereof and thus may exhibit excellent flame retardancy.

In one embodiment, the non-halogenated phosphorus flame retardant may be combusted to form the char in the form of glass fragments to improve flame retardancy of various polymer resins.

Further, the non-halogenated phosphorus flame retardant in accordance with the present disclosure exhibits the volume expansion by at least 10 times, preferably 70 to 80 times of the initial volume thereof during combustion thereof, and thus may impart excellent flame retardancy to various polymer resins even at a small amount.

This is due to the multi-synergistic effect between the three phosphate groups, thymine base and ribose contained in thymidine triphosphate (TTP). Thus, the non-halogenated phosphorus flame retardant in accordance with the present disclosure may exhibit excellent flame-retardant properties without the presence of other additives, and thus may be applied to several polymer resins to improve the flame retardancy of the polymer resin.

In one example, the non-halogenated phosphorus flame retardant according to an embodiment of the present disclosure includes guanosine triphosphate (GTP).

Like adenosine triphosphate (ATP), guanosine triphosphate (GTP) is a material containing ribose as pentose, and three phosphate groups, and has guanine as a base.

Guanosine triphosphate (GTP) also contains phosphorus (P), nitrogen (N), and carbon (C), which are three essential components in flame retardant materials in a molecule itself thereof and thus may exhibit excellent flame retardancy.

In one embodiment, the non-halogenated phosphorus flame retardant may be combusted to form the char in the form of glass fragments to improve flame retardancy of various polymer resins.

Further, the non-halogenated phosphorus flame retardant in accordance with the present disclosure exhibits the volume expansion by at least 10 times, preferably 70 to 80 times of the initial volume thereof during combustion thereof, and thus may impart excellent flame retardancy to various polymer resins even at a small amount.

This is due to the multi-synergistic effect between the three phosphate groups, guanine base, and ribose contained in guanosine triphosphate (GTP). Thus, the non-halogenated phosphorus flame retardant in accordance with the present disclosure may exhibit excellent flame-retardant properties without the presence of other additives, and thus may be applied to several polymer resins to improve the flame retardancy of the polymer resin.

Specifically, referring to FIG. 1, the present disclosure may provide a non-halogenated phosphorus flame-retardant polymer resin including a polymer resin, and the above-described non-halogenated phosphorus flame-retardant coated on a surface of the polymer resin to exhibit flame-retardant properties.

In one embodiment, the polymer resin may include at least one selected from polyurethane, polyethylene, EVA (Ethylene-vinyl acetate) and cotton fibers. Polyurethane may be preferably used as the polymer resin. However, the present disclosure is not limited thereto.

Further, the non-halogenated phosphorus flame retardant is preferably contained in an amount of 30 wt % or greater based on a total weight of the non-halogenated phosphorus flame-retardant polymer resin. When the non-halogenated phosphorus flame retardant is contained in an amount of smaller than 30 wt %, the flame retardant effect is insignificant, resulting in a problem requiring additional additives to exhibit the flame retardant effect.

In one example, the flame-retardant polymer resin may be prepared in a following manner.

First, an aqueous solution containing at least one selected from adenosine triphosphate (ATP), cytidine triphosphate (CTP), thymidine triphosphate (TTP), and guanosine triphosphate (GTP) is prepared in S 100.

In this regard, the aqueous solution is preferably deionized (DI) water having a pH of 5 to 8, preferably 6.8 to 7.4. This is because when the pH is out of the above range, adenosine triphosphate (ATP), cytidine triphosphate (CTP), thymidine triphosphate (TTP), and guanosine triphosphate (GTP) are not well soluble in the solution.

More preferably, a buffer solution of pH 5 to 8 may be used as the aqueous solution. When the pH in an aqueous solution changes rapidly, deformation and destruction of adenosine triphosphate (ATP), cytidine triphosphate (CTP), thymidine triphosphate (TTP), and guanosine triphosphate (GTP) occur. In this regard, the buffer solution may prevent such pH change so as to bring out the maximum performance of the flame retardant material.

In addition, when the aqueous solution includes the buffer solution of pH 5 to 8, —OH in the buffer solution acts as a cross-linking agent, so that the flame retardant material (ATP in FIG. 1) is not aggregated and precipitated but is adsorbed to the polymer material.

In one example, the buffer solution may include, for example, TAE (Tris acetate/EDTA), HEPES (Hydroxyethyl piperazine Ethane Sulfonic acid), PBS (Phosphate buffered saline), TES, Bis-Tris, etc. of pH 5 to 8. However, the present disclosure is not limited thereto.

Next, the polymer resin is immersed in and react with the aqueous solution in S 200.

In one embodiment, the polymer resin may be polyurethane, polyethylene, EVA (Ethylene-vinyl acetate), cotton fiber, or the like. Further, in S 200, the polymer resin is immersed in the aqueous solution for 1 to 3 hours.

Finally, the polymer resin after the reaction is dried in S 300.

In this regard, it is preferable to perform the drying for about 6 hours at a temperature of 25 to 60° C. When the drying temperature is below 25° C., the coating of the flame retardant material is not sufficiently performed. When the drying temperature exceeds 60° C., the char formation occurs in the drying step, such that the physical properties of the polymer resin itself cannot be maintained.

However, when the drying is performed at a temperature of 25 to 60° C., the flame retardant material is appropriately coated on the surface of the polymer resin to improve the flame-retardant properties of the polymer resin.

According to the present disclosure, the pH of the aqueous solution may be adjusted to 5 to 8 to increase the solubility of ATP, CTP, TTP, and GTP in the solution, such that a large amount of the flame retardancy material may be coated on the polymer resin. In particular, when the buffer solution of pH 5 to 8 is used as the aqueous solution, the deformation and destruction of the flame retardant material may be prevented such that the flame retardant ability may be maximized.

In addition, when the drying temperature is controlled to 25 to 60° C., the non-halogenated phosphorus flame-retardant polymer resin having optimal flame-retardant properties may be prepared while maintaining the physical properties of the polymer resin.

Hereinafter, contents of the present disclosure will be further described along with specific Examples.

### Present Example 1

Adenosine triphosphate (ATP) was added to a TAE (Tris acetate/EDTA) buffer solution (0.1M, 40 mL) of pH 6.8 to 7.4 and was dissolved therein. In this regard, an amount of adenosine triphosphate dissolved in the solution was 200 mg/ml.

Then, a polyurethane foam was added to the adenosine triphosphate (ATP) aqueous solution, and was immersed therein for 2 hours. The polyurethane foam on which the adenosine triphosphate (ATP) aqueous solution was sufficiently wet was squeezed to remove the solution therefrom. The polyurethane foam was dried at room temperature for 6 hours. Thus, the adenosine triphosphate (ATP) was coated on a surface of the polyurethane foam (hereinafter referred to as PU-ATP).

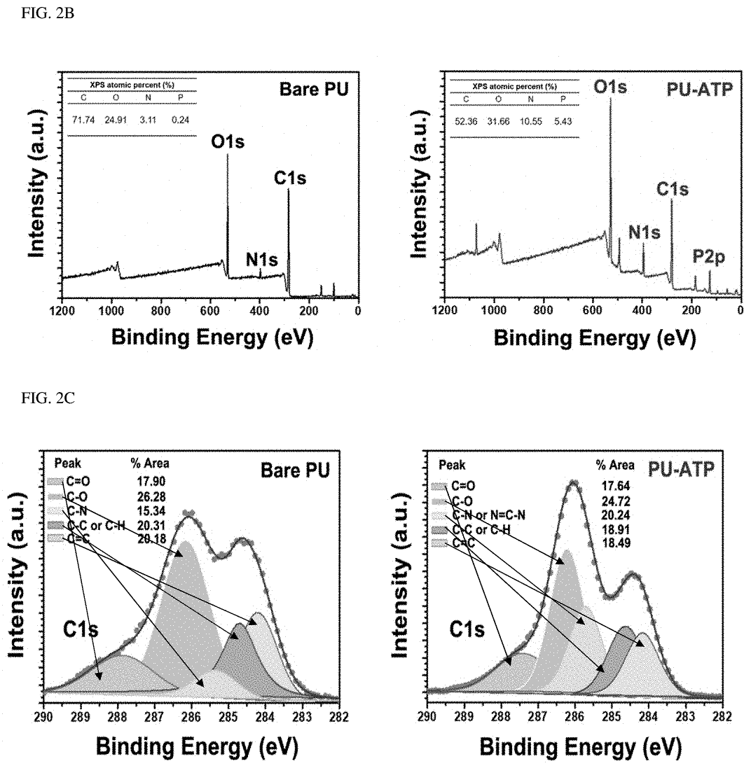

FIG. 2A shows a SEM image of the PU-ATP prepared according to Present Example 1 of the present disclosure. FIG. 2B shows the results of analyzing the chemical composition of the polyurethane surface before and after ATP coating using X-ray photoelectron spectroscopy (XPS).

Referring to FIG. 2A, it may be identified that ATP is uniformly coated on the polyurethane surface, and thus the surface becomes rough.

Further, referring to FIG. 2B, regarding the polyurethane (Bare PU) before ATP coating, peaks of four elements corresponding to carbon (C1s), nitrogen (N1s), oxygen (O1s), and phosphorus (P2p) are observed. After the ATP coating, peaks corresponding to phosphorus (P2p) and nitrogen (Nis) significantly increase, thus indicating that ATP is successfully coated on the polyurethane surface. Specifically, after the ATP coating, a nitrogen (N1s) concentration increases by 7.44% and a phosphorus concentration increases by 5.19%.

Further, referring to FIG. 2C which shows the XPS spectrum of C1s, it may be identified that polyurethane before ATP coating exhibits 288.2 eV at C═O bond, 286.5 eV at C—O bond, 285.4 eV at C—N bond, 284.3 eV C—C or C—H bond, and 283.6 eV at C═C bond.

Polyurethane after ATP coating also exhibits the same five peaks as those of polyurethane before ATP coating. However, in polyurethane after ATP coating, a content of C—N bond at 285.4 eV increases from 15.34% to 20.24% due to N═C—N of adenine base of ATP.

Evaluation of Flame-Retardant Properties of PU-ATP

1) Evaluation of Flame-Retardant Properties of Bare PU and Present Example 1

Evaluation was conducted to compare the flame-retardant properties of a conventional combustible polyurethane (Bare PU, Comparative Example 1) and a flame retardancy polyurethane (PU-ATP) according to Present Example 1 of the present disclosure with each other.

Specifically, a polyurethane foam having a volume of 50×50×20 mm³, which is ¼ of that as specified by the ASTM E1354 standard was used as a specimen. The bare PU and the PU-ATP are combusted using a gas torch for 1 minute. The flame-retardant properties thereof were evaluated.

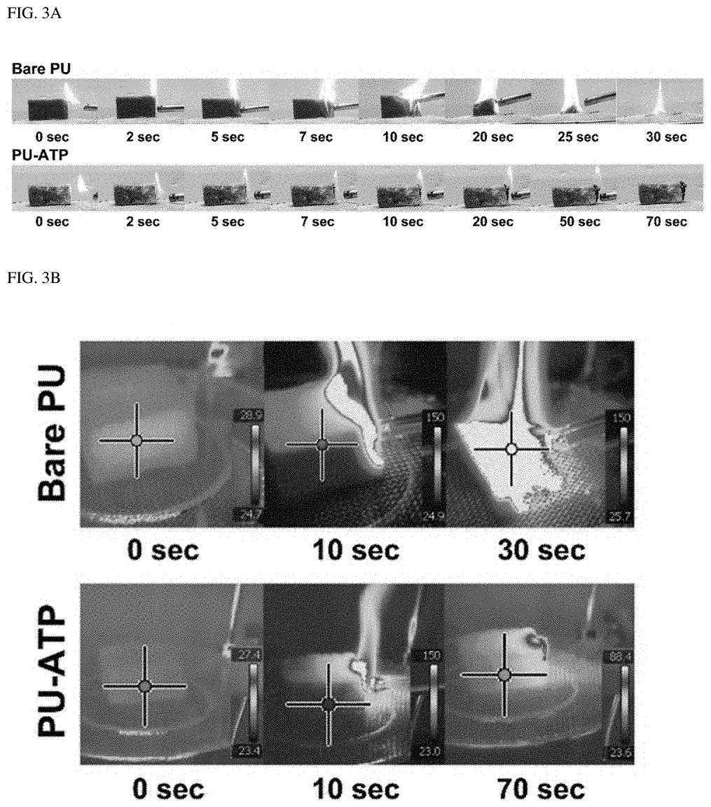

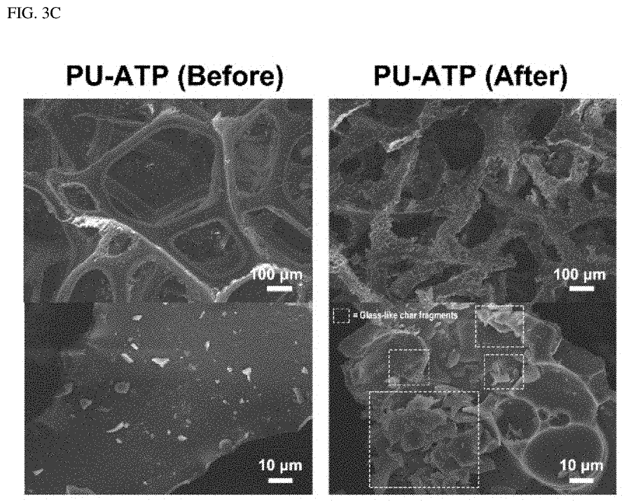

FIG. 3 shows the evaluation results of the flame-retardant properties of Present Example 1 and Comparative Example 1.

As shown in FIG. 3A, regarding the bare PU, combustion started within seconds, and a fire occurred as the melt fell.

On the contrary, it was identified that when PU-ATP was burned, PU-ATP instantly swelled due to P—N bond between phosphorus of phosphoric acid and nitrogen of adenine base centered on ribose present in adenosine triphosphate such that the char was formed to block the flame. Further, it was identified that the inflow of additional oxygen was blocked due to the incombustible gas generated during combustion thereof.

In one example, referring to FIG. 3B showing a thermal image, it was identified that a hot spot with a temperature exceeding 450° C. was observed in an entire area of the bare PU, whereas only low-temperature local hot spots were observed on the surface of PU-ATP, and heat propagation was blocked due to the ATP.

FIG. 3C shows SEM images before and after combustion of Present Example 1 of the present disclosure.

Referring to FIG. 3C, after combustion, a connected char layer was observed on the polyurethane surface. The char layer serves to physically prevent flame propagation.

Further, the char layer resulting from ATP had the form of glass fragments with a size of several hundred nm to several μm, which is a different shape from that of a conventionally observed char.

2) Con-Calorimeter Test Evaluation of Bare PU and Present Example 1

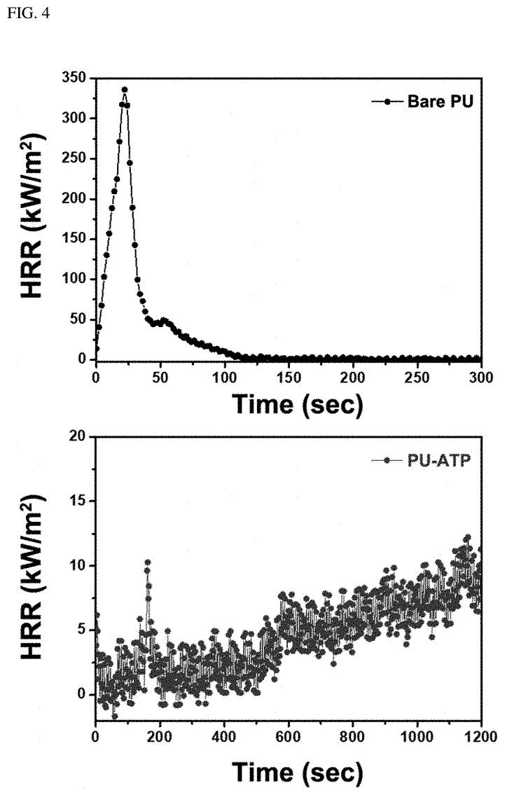

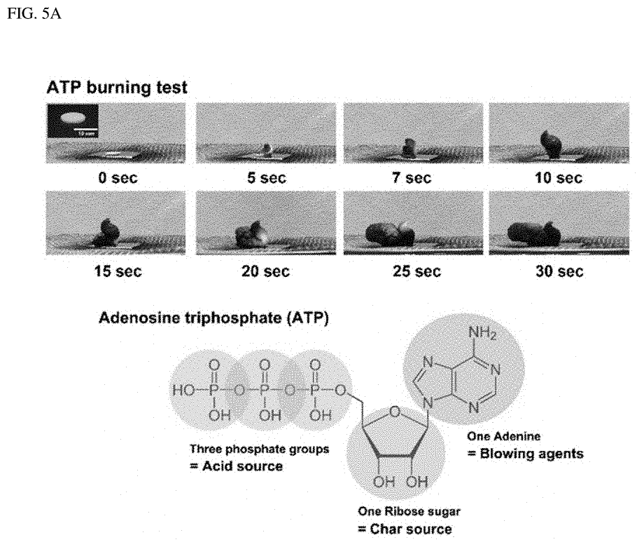

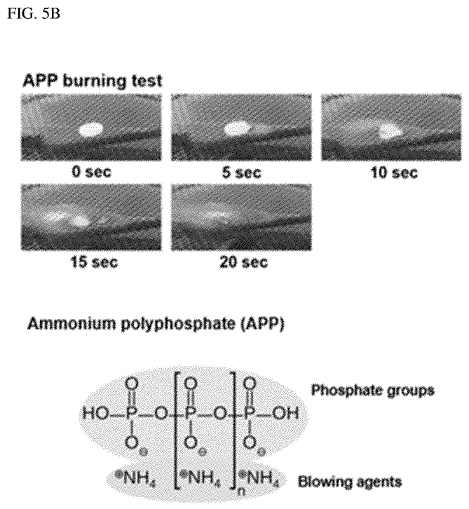

A con-calorimeter test was performed on the conventional combustible polyurethane (Bare PU, Comparative Example 1) and the flame retardancy polyurethane (PU-ATP) according to Present Example 1 of the present disclosure. The flame retardancy of ATP is evaluated quantitatively according to the ASTM E1354 standard. The results are shown in FIG. 4 and Table 1.

TABLE 1

| | | Average mass | | | |
|---|---|---|---|---|---|
| | P-HRR | loss rate | TSR | CO yield | CO₂ yield |
| Sample | (kW/m²) | (g/m²s) | (m²/m²) | (kg/kg) | (kg/kg) |
| Bare PU | 335.8 | 6.03 | 86.2 | 0.068 | 2.01 |
| PU-ATP | 12.2 | 0.94 | 42.0 | 0.051 | 0.29 |

Referring to FIG. 4, the bare PU exhibited a large peak heat release rate (P-HRR) and a short burning time smaller than 100 seconds.

On the contrary, regarding PU-ATP as an example of the present disclosure, the heat release rate (P-HRR) was significantly reduced by 96.4% compared to Comparative Example. This means that the ATP coating significantly improves the flame retardancy of polyurethane.

Further, PU-ATP exhibited a steady increase in the HRR value over time. Very slow thermal decomposition of PU-ATP occurred compared to Comparative Example.

In one example, referring to Table 1, PU-ATP exhibited a total smoke release rate (TSR) reduced by 51.3% and CO₂ emission reduced by 85.6%, compared to Bare PU as a comparative example.

In view of these results, the PU-ATP according to the present disclosure generates a large amount of incombustible gas due to abundant adenine base during combustion thereof, and may effectively prevent combustible urethane from burning due to the char resulting from the ATP.

3) Comparison Between APP and Present Example 1

In order to compare the flame-retardant properties of ammonium polyphosphate (APP) (Comparative Example 2) as a conventional phosphorus flame retardant and adenosine triphosphate (ATP) with each other, each of the ammonium polyphosphate (APP) (Comparative Example 2) and the adenosine triphosphate (ATP) was prepared in a form of pellets (10 mm×10 mm). The pellets were combusted using a gas torch for 1 minute to evaluate the flame-retardant properties thereof. The results are shown in FIG. 5.

As shown in FIG. 5, after combustion, a volume of adenosine triphosphate (ATP) increased by at least 70 times of an initial volume thereof within 30 seconds. However, after combustion, APP did not form the char by itself due to lack of carbon and disappeared.

This is because adenosine triphosphate (ATP) has ribose contributing to the formation of char. Thus, the char layer of a volume larger by at least 10 times than the initial volume thereof may be formed.

Specifically, as the temperature of adenosine triphosphate (ATP) according to the present disclosure rises, the adenosine triphosphate (ATP) releases a phosphate group acting as an acid source which reacts with ribose acting as a carbon source to form a carbonaceous layer.

Then, the incombustible gas decomposed from adenine may help to expand the carbonaceous layer to form the char, and may block additional oxygen supply.

4) Evaluation of Flame-Retardant Properties Based on pH of Aqueous Solution

To analyze the flame-retardant properties of PU-ATP based on the pH range of the aqueous solution, polyurethane foam coated with ATP was prepared in the same manner as that in Present Example 1 except that pH of the aqueous solution was adjusted to pH 3 to 4 (Sample 1), pH 5 to 6 (Sample 2), pH 7 to 8 (Sample 3), pH 9 to 10 (Sample 4), pH 11 to 12 (Sample 5), and pH 13 to 14 (Sample 6),

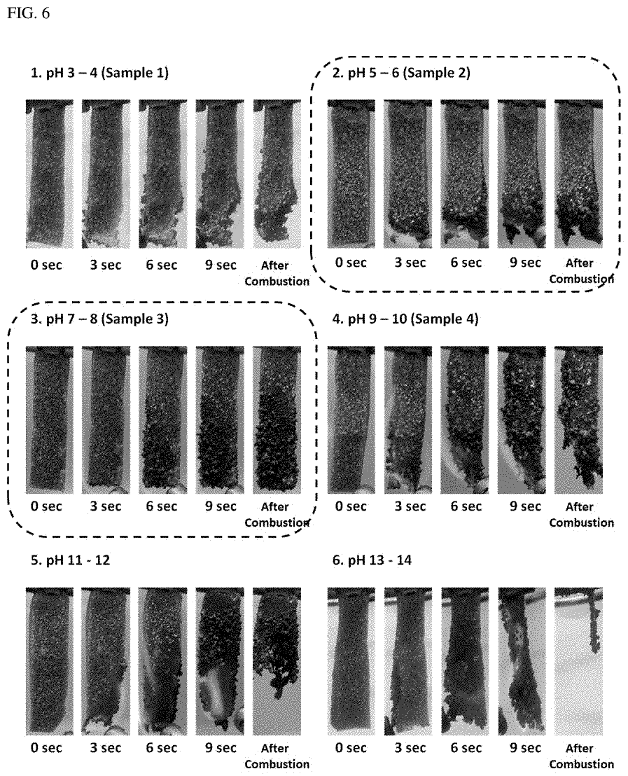

Afterwards, the samples 1 to 6 were combusted with a gas torch for 10 seconds. The flame-retardant properties thereof were evaluated, and the results are shown in FIG. 6.

Referring to FIG. 6, it may be identified that the best flame retardancy is exhibited in the pH range of 6.7 to 8.4 (Sample 3) which is the optimum pH for solubilization of adenosine triphosphate (ATP). The sample 2 in the pH range of 5 to 6 also exhibited excellent flame retardancy.

However, the samples out of the above range had insignificant flame retardant effect. Especially when the pH was 9 or higher, most of the samples did not maintain their shapes. This is due to the nature of adenosine triphosphate (ATP) that ATP decomposes at high pH.

Therefore, excellent flame-retardant properties may be exhibited when the pH range of the aqueous solution is in a range of 5 to 8.

5) Evaluation of Flame-Retardant Properties Based on Whether Aqueous Solution is Buffer Solution

To analyze the flame-retardant properties of PU-ATP based on the whether the aqueous solution is the buffer solution, ATP-coated polyurethane foam was prepared in the same manner as that in Present Example 1, except that each of deionized (DI) water and TAE (Tris acetate/EDTA) having the same pH (8.01) was prepared as the aqueous solution.

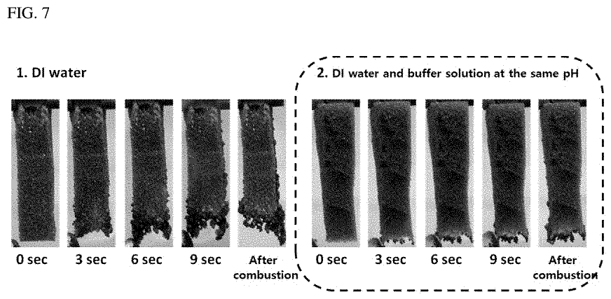

Afterwards, the ATP-coated polyurethane foam was combusted with a gas torch for 10 seconds. The flame-retardant properties thereof was evaluated, and the results are shown in FIG. 7.

Referring to FIG. 7, both samples using the deionized (DI) water and the buffer solution, respectively exhibited generally excellent flame retardancy. However, when the buffer solution was used as the aqueous solution, the flame retardant performance of the ATP-coated polyurethane foam was relatively higher than that when the deionized (DI) water was used as the aqueous solution.

Specifically, comparing the samples shown in FIG. 7 with each other, it may be identified that when the buffer solution is used as the aqueous solution, that ATP is not aggregated or precipitated but is evenly adsorbed on the surface of the polyurethane foam. This is because —OH in the buffer solution served as a cross-linking agent.

Further, the buffer solution prevents the rapid pH change even when acidic ATP is added thereto, thereby preventing the deformation and destruction of ATP, and maximizing the flame retardant ability of ATP.

Therefore, when the coating of the ATP on the PU is performed using the buffer solution of pH 5 to 8, the flame retardancy of ATP may be maximized

6) Evaluation of Flame-Retardant Properties Based on Drying Temperature Condition

To analyze the flame-retardant properties of PU-ATP based on the drying temperature condition, the polyurethane foam coated with ATP was prepared in the same manner as that in Present Example 1 except that the TAE (Tris acetate/EDTA) solution of pH (8.01) was used as the aqueous solution and the drying temperature was set to each of freeze-drying (Sample 1a), room temperature (Sample 2A), 60° C. (Sample 3A), and 90° C. (Sample 4a).

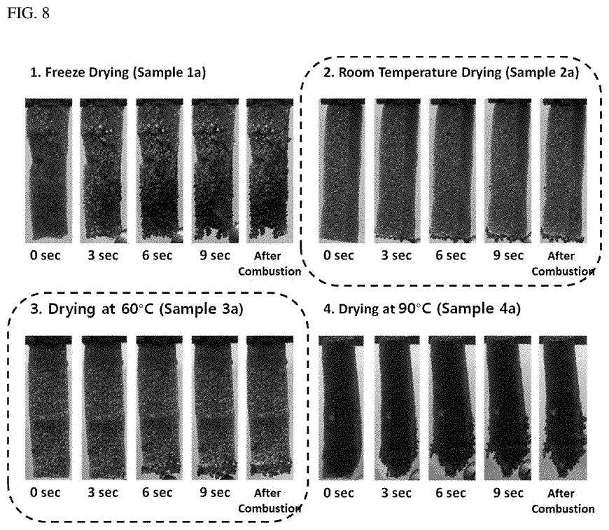

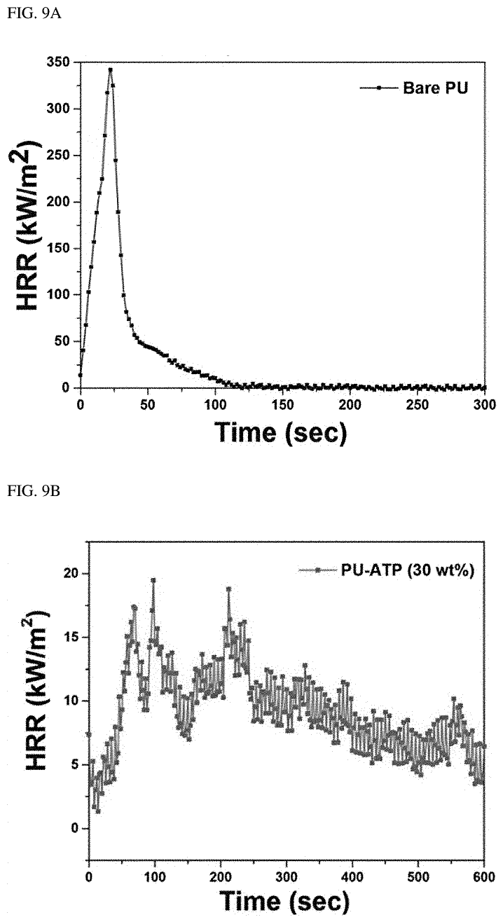

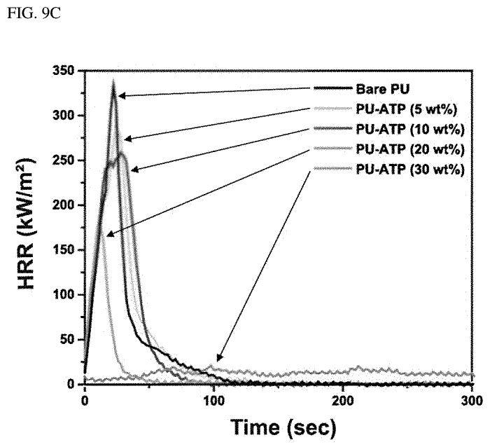

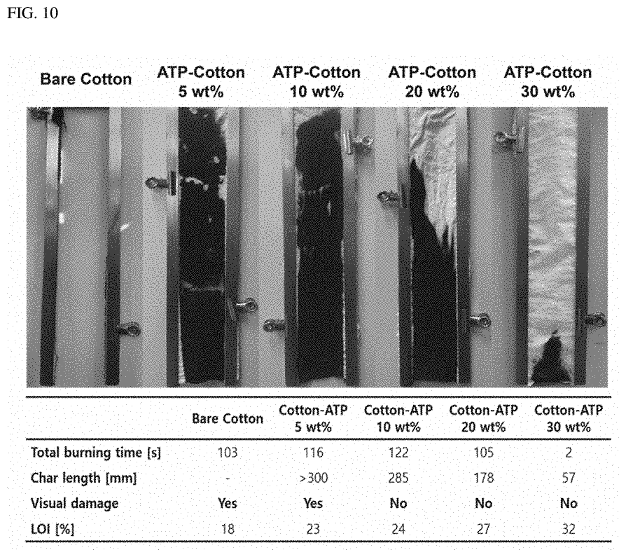

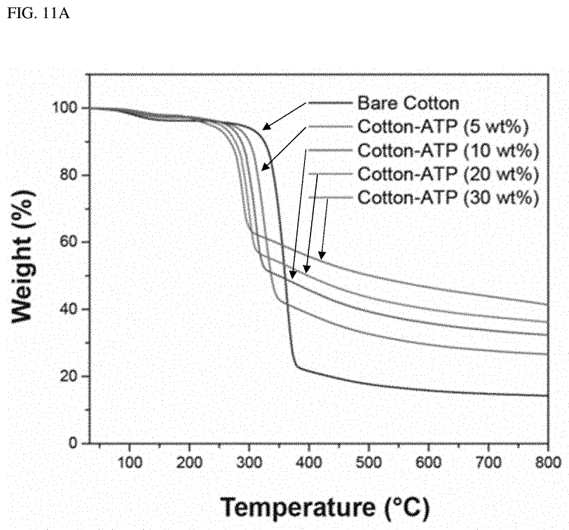

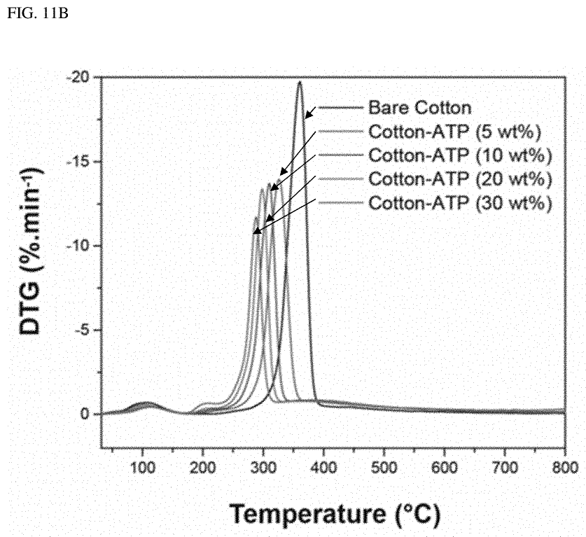

Afterwards, the samples 1a to 4a were combusted using a gas torch for 10 seconds. The flame-retardant properties thereof were evaluated, and the results are shown in FIG. 8.

Referring to FIG. 8, it may be identified that all four samples exhibit generally good flame retardancy, whereas the flame retardant ability in the freeze-drying (Sample 1a) and 90° C. (Sample 4a) drying conditions is reduced compared to those of other samples.

It was identified that in the freeze-drying condition (Sample 1a), ATP was not sufficiently coated on the surface of the PU and a significant portion thereof was precipitated as white ATP powders. It was identified that in the 90° C. drying condition (Sample 4a), the char formation has already occurred on the surface of the PU such that the polyurethane foam itself has not maintained its physical properties.

Therefore, the PU-ATP prepared under the drying conditions of 25 to 60° C. may exhibit excellent flame-retardant properties.

### Present Example 2

The inventors of the present disclosure secured detailed data on additional flame-retardant properties based on Present Example 2, and details thereof are as follows.

*Used Materials

Adenosine 5′-(ATP) disodium salt hydrate (5′-ATP 2Na hydrate, 25 g) powders were purchased from Tokyo Chemical Industry Co. (Tokyo, Japan) and stored at 4° C. Tris-buffer solution (1.0M, pH 8.0, 100 mL) and ammonium polyphosphate (APP) were purchased from Sigma-Aldrich, and diluted in deionized water (DI) before use. Polyurethane (PU) foam with 100 ppi and Twill Cotton were obtained from Wonchang Co.

*ATP Treatment Process on PU Foam

ATP solution (200 mM) was prepared by slowly dissolving 5′-ATP 2Na hydrate powders in a diluted Tris buffer solution (0.1M, 40 mL) under mechanical stirring (500 rpm) for 10 minutes. When the PU foam was immersed in the white ATP solution for 1 hour, the solution became clear. After immersing the foam in a sufficient amount of solution, the foam was removed from the solution. Since the ATP solution remains inside the foam, the foam was squeezed as much as possible to remove the solution therefrom, and then was lyophilized by soaking the foam a freeze dryer for 24 hours. Finally, the ATP-coated PU foam was washed once with deionized water and incubated at 50° C. for 6 hours. A mass of ATP attached to the foam was determined based on a difference between weighing results of the sample before and after ATP coating with a balance (Innoteem IB-210, ±10-4 g). A content of the ATP coated on PU foam is calculated based on a following Equation.

$$ATP weight percentage ( wt \% ) = \frac{m 2 - m 1}{m 2} \times 100$$

$$m 1 = \text{mass of PU foam}$$

$$m 2 = \text{mass of ATP-coated PU foam}$$

*Preparation of Samples for Evaluation of Flame-Retardant Properties

To identify the flammability of the samples (bare PU and PU-ATP), a miniaturized PU foam sample with a volume of 50×50×20 mm³ as ¼ of the ASTM E1354 standard was used. An experiment was conducted to investigate the flame retardancy of ATP using the sample (PU-ATP) prepared via the above ATP coating process. The PU foam sample used in this experiment had an ATP content of 30 wt %. Both the bare PU and PU-ATP samples were burned for 1 minute using a torch. To further demonstrate the combustion behavior of ATP itself, the specimen was prepared in a shape of a coin with a diameter of 10 mm and a thickness of 1 mm via a pressing process for about 60 seconds under a weight of 1 ton. ATP pellets were placed on a mesh and heated with a torch for 30 seconds. Further, a parallel experiment was also performed using APP as a control. For the cone calorimeter test, each of specimen sets (0 wt %, 5 wt %, 10 wt %, 20 wt %, %, 30 wt %, 6 samples) was prepared. Therefore, 5 sets of the samples (5 sets*6 samples/set=30 samples in total) of bare PU and PU-ATP having different weight percentages of AT were used. For a UL94 HBF test, each of the samples (0 wt %, 5 wt %, 10 wt %, 20 wt %, 30 wt %, 3 samples) with a volume of 150×50×10 mm³ was prepared and was tested using a 38 mm high flame for 60 seconds.

*Preparation of ATP-Coated Cotton for Evaluation of Flame Retardancy Characteristics

To further demonstrate the flame retardancy of ATP using different combustible materials, a cotton sample of a 76×300 mm² size was prepared and complies with the ASTM D6413 standard. The cotton with each of various ATP contents (0 wt %, 5 wt %, 10 wt %, 20 wt %, 30 wt %) was prepared via a simple soaking procedure of the cotton into an ATP solution. The cotton-ATP sample was dried in an oven at 50° C. for 6 hours, washed once with DI water, and then dried in an oven at 50° C. for 3 hours. The dried sample was burned for 12 seconds according to the ASTM D6413 standard.

*LOI Test

A LOI test was conducted on both PU foam and the cotton with each of different contents of ATP (0 wt %, 5 wt %, 10 wt %, 20 wt %, 30 wt %). The PU foam sample was produced according to the GB/T2406-1993 standard (100×10×10 mm³). The cotton sample was prepared according to the ASTM D2863-2000 standard (50×140 mm²). After identifying that a top of the sample was ignited, a minimum oxygen concentration at which the sample was entirely burned or not extinguished after 3 minutes was identified to measure a LOI value. Each sample was prepared in triplicate under the identical condition and the average LOI value was determined.

*Characteristics of ATP Coated on PU Foam

An amount of ATP adsorbed on the PU foam was about 30 wt % of a total mass thereof. A color of the PU surface after the coating was slightly changed to white. Before micro-analyzing the PU-ATP, a tensile strength test according to ISO 1798:2008 was performed thereon to identify whether the 30 wt % ATP coating affects the mechanical strength of the PU foam. An ultimate strength of the PU foam decreased by about 10% after the ATP coating. However, it was identified that when a simple restoration test was performed thereon, the PU-ATP had similar restoration properties to that of the bare PU.

*Flame-Retardant Properties

To qualitatively investigate the flammability of each of the bare PU and the 30 wt % ATP-coated PU foam, a direct combustion test was conducted on a PU foam sample for 1 minute (See FIG. 3). In this experiment, a miniaturized PU foam sample with a volume of 50×50×20 mm³ specified by ASTM E154 was used. Regarding the bare PU, active combustion of the foam started within a few seconds, and the fire was entirely transmitted to the entire PU due to melt dripping. However, regarding the PU-ATP foam, even after being ignited for greater than 1 minute, the fire did not spread to the central part of the PU-ATP foam, and only a small amount of smoke was emitted therefrom, and the flame was quickly extinguished. Thus, the PU-ATP foam exhibited significant self-extinguishing capability. These results had a close relationship with the fact that only local hot spots with low temperature were observed on the PU-ATP surface, whereas relatively large hot spots with temperatures exceeding 450° C. were observed in the entire area of the bare PU (see FIG. 3). FIG. 3C shows the morphological changes of the ATP-coated PU surface before and after burning. After burning, a connected char layer was observed on the PU surface. The char layer may physically impede the propagation of fire. To quantitatively identify the flame retardancy of ATP, both UL94 HBF and LOI tests were performed on each of PU foams coated with ATPs at various concentrations. When the PU foam was coated with 20 wt % or greater of ATP, a HF-1 grade was obtained, and this sample did not burn even at oxygen concentration of 28 to 31% (see Table 2). This result objectively suggests that a certain concentration of ATP may induce sufficient flame retardancy on the PU foam.

TABLE 2

| | | PU-ATP | PU-ATP | PU-ATP | PU-ATP |
|---|---|---|---|---|---|
| | Bare PU | 5 wt % | 10 wt % | 20 wt % | 30 wt % |
| PASS/NO | NO | PASS | PASS | PASS | PASS |
| UL94 HBF | — | HBF | HF-2 | HF-1 | HF-1 |
| test | | | | | |
| LOI [%] | 18 | 20 | 22 | 28 | 31 |

*Con-Calorimeter Test

The con-calorimeter test was conducted on each of the bare PU and the PU-ATP in order to characterize an amount of flame spread based on an ignition time on the polymer material and to obtain quantitative results on flame retardancy thereof. A flame spread test was performed on the sample using a con-calorimeter with a heat flux of 35 kW/m² according to ASTM E1354 (or ISO 5660). The con-calorimeter test provides heat release rate (HRR) of each of the burning samples which is one of the most important values used to evaluate a material's maximum flammability and flashover potential. The HRR curves of the bare PU and the PU coated with 30 wt % ATP are shown in FIG. 9A and FIG. 9B, respectively. Table 3 below presents a summary of the con-calorimeter test.

TABLE 3

| | | | Average mass | | | |
|---|---|---|---|---|---|---|
| | THR | P-HRR | loss rate | TSR | Time to | AEHC |
| Sample | (MJ/m²) | (kW/m²) | (g/m²s) | (m²/m²) | ignition (s) | (MJ/kg) |
| Bare PU | 8.56 | 341.8 | 5.85 | 35.8 | 2 | 22.39 |
| PU-ATP | 1.52 | 19.5 | 1.52 | 68.0 | 284 | 6.93 |

Referring to FIG. 9C, it is identified that in the con-calorimeter test, the total HRR significantly decreases as the content of ATP increases. In particular, the HRR curve of the 30 wt % PU-ATP exhibited an extremely low peak heat release rate (P-HRR, 94.3%) compared to that of the bare PU. Further, it was observed that the bare PU was ignited rapidly in 2 seconds, whereas a time taken for the PU-ATP to be ignited was greater than 284 seconds. This result suggests that the PU-ATP coating significantly prevents the burning process and rapid flame diffusion of the bare PU due to the slow thermal decomposition of PU-ATP. Above all, it was identified that a thick char layer resulting from ATP was rapidly generated on the PU surface, and this layer acted as a physical barrier to prevent the spread of fire. Further, the PU-ATP exhibited the total smoke release (TSR) increased by 90% compared to that of the bare PU. This is due to a large amount of non-flammable ammonia gas released from the rich adenine.

*Cotton Flammability Test

Additionally, a flame retardancy test using an ATP-coated cotton fabric (Cotton-ATP) was conducted to identify whether flame retardancy of ATP is valid on other flammable materials. An entire test procedure was as specified by ASTM D6413 (76×300 mm², see FIG. 10). A bare cotton sample was highly flammable and entirely disappeared in 103 seconds. On the contrary, 30 wt % ATP-coated cotton (Cotton-ATP) exhibited significantly excellent flame retardancy with only slight soot generation after 12 seconds of fire. Based on a result of the LOI test, it is identified that the cotton sample requires 32% or higher oxygen concentration for ignition. Further, due to the formation of the char layer on the surface, only negligible variation in the morphology and microstructure of the sample was observed even after the entire combustion test procedure. These results indicate that ATP itself is an excellent flame retardant (FR) that may effectively suppress the flammability of various flammable materials. FIG. 10 shows a vertical burning test result of each of ATP (Cotton-ATP) coated with different concentrations of ATP and the bare cotton (Bare Cotton) according to ASTMD 6413.

*Thermal Behavior of Cotton-ATP

The thermal characteristics of the cotton samples (Cotton-ATP) coated with different concentrations of ATP and bare cotton are shown in FIG. 11A and FIG. 11B. FIG. 11A and FIG. 11B show the TGA and DTG curves of cottons coated with ATP at various concentrations, respectively. From the TGA curve, it was observed that a larger amount of ATP was coated as the weight loss started in a rapider manner. The reason is that the ATP evaporates earlier. However, only 17% residue of the bare cotton remained after the thermal decomposition, whereas 46% residue of the 30 wt % Cotton-ATP remained after the thermal decomposition. This is due to the thick char layer resulting from the ATP as formed on the surface. This indicates that ATP may prevent thermal decomposition inside the cotton. The decomposition temperature of cotton may be lowered due to the ATP coating. This is due to the catalytic thermal decomposition of the cotton on which ATP is present (see FIG. 11B). Above all, it was identified that when the ATP concentration in the Cotton-ATP increases, the decomposition temperature of the cotton is lowered. Therefore, it was identified that the ATP coating is very meaningful in not only lowering the decomposition temperature of cotton but also suppressing additional decomposition of the cotton at high temperature.

A description of the presented embodiments is provided so that a person skilled in the art of any of the present disclosure may use or practice the present disclosure. Various modifications to these embodiments will be apparent to those skilled in the art of the present disclosure. The general principles defined herein may be applied to other embodiments without departing from the scope of the present disclosure. Thus, the present disclosure should not be limited to the embodiments as presented herein, but should be interpreted in the widest scope consistent with the principles and novel features as presented herein.

1. A non-halogenated phosphorus flame retardant containing adenosine triphosphate (ATP).

2. The non-halogenated phosphorus flame retardant of claim 1, wherein the non-halogenated phosphorus flame retardant is combusted to form char in a form of glass fragments.

3. The non-halogenated phosphorus flame retardant of claim 1, wherein when the non-halogenated phosphorus flame retardant is combusted, the non-halogenated phosphorus flame retardant exhibits a volume expansion by at least 10 times of an initial volume thereof.

4. A non-halogenated phosphorus flame retardant containing cytidine triphosphate (CTP).

5. The non-halogenated phosphorus flame retardant of claim 4, wherein the non-halogenated phosphorus flame retardant is combusted to form char in a form of glass fragments.

6. The non-halogenated phosphorus flame retardant of claim 4, wherein when the non-halogenated phosphorus flame retardant is combusted, the non-halogenated phosphorus flame retardant exhibits a volume expansion by at least 10 times of an initial volume thereof.

7. A non-halogenated phosphorus flame retardant containing thymidine triphosphate (TTP).

8. The non-halogenated phosphorus flame retardant of claim 7, wherein the non-halogenated phosphorus flame retardant is combusted to form char in a form of glass fragments.

9. The non-halogenated phosphorus flame retardant of claim 7, wherein when the non-halogenated phosphorus flame retardant is combusted, the non-halogenated phosphorus flame retardant exhibits a volume expansion by at least 10 times of an initial volume thereof.

10. A non-halogenated phosphorus flame retardant containing guanosine triphosphate (GTP).

11. The non-halogenated phosphorus flame retardant of claim 10, wherein the non-halogenated phosphorus flame retardant is combusted to form char in a form of glass fragments.

12. The non-halogenated phosphorus flame retardant of claim 10, wherein when the non-halogenated phosphorus flame retardant is combusted, the non-halogenated phosphorus flame retardant exhibits a volume expansion by at least 10 times of an initial volume thereof.

13. A non-halogenated phosphorus flame-retardant polymer resin comprising:
a polymer resin; and
the non-halogenated phosphorus flame retardant according to claim 1 coated on a surface of the polymer resin so as to exhibit flame-retardant properties.

14. The non-halogenated phosphorus flame-retardant polymer resin of claim 13, wherein the polymer resin includes at least one selected from polyurethane, polyethylene, EVA (ethylene-vinyl acetate), and cotton fibers.

15. The non-halogenated phosphorus flame-retardant polymer resin of claim 13, wherein the non-halogenated phosphorus flame retardant is contained at a content of 30 wt % or greater based on a total weight of the non-halogenated phosphorus flame-retardant polymer resin.

16. A method for preparing a non-halogenated phosphorus flame-retardant polymer resin, the method comprising:
preparing an aqueous solution containing therein at least one selected from adenosine triphosphate (ATP), cytidine triphosphate (CTP), thymidine triphosphate (TTP) and guanosine triphosphate (GTP);
immersing in and reacting with a polymer resin in the aqueous solution; and
drying the polymer resin after the reaction.

17. The method for preparing the non-halogenated phosphorus flame-retardant polymer resin of claim 16, wherein the aqueous solution includes deionized (DI) water of pH 5 to 8.

18. The method for preparing the non-halogenated phosphorus flame-retardant polymer resin of claim 16, wherein the aqueous solution includes a buffer solution of pH 5 to 8.

19. The method for preparing the non-halogenated phosphorus flame-retardant polymer resin of claim 16, wherein the drying is carried out at a temperature in a range of 25 to 60° C.
